(19) United States
(12) Patent Application Publication
(10) Pub. No.: US 2019/0225227 A1
(43) Pub. Date: Jul. 25, 2019

(54) TIRE-MOUNTED SENSOR AND ROAD SURFACE CONDITION ESTIMATION DEVICE INCLUDING SAME

(71) Applicant: DENSO CORPORATION, Kariya-city, Aichi-pref. (JP)

(72) Inventors: Masashi MORI, Kariya-city (JP); Takatoshi SEKIZAWA, Kariya-city (JP); Ryosuke KANBAYASHI, Kariya-city (JP)

(21) Appl. No.: 16/313,069

(22) PCT Filed: Jun. 23, 2017
(86) PCT No.: PCT/JP2017/023193

§ 371 Date: Dec. 24, 2018

(30) Foreign Application Priority Data
Jul. 1, 2016 (JP) 2016-131789
Jun. 5, 2017 (JP) 2017-110682

(51) Int. Cl. B60W 40/06; G01C 7/02; B60C 19/00

(52) U.S. Cl. CPC B60W 40/06; B60C 2019/004; B60C 19/00; G01C 7/02

(57) ABSTRACT

When a road surface condition does not change, road surface data is transmitted by a tire-mounted sensor at a rate of once every time a tire rotates a plurality of times, in order to reduce the power consumption from a power source. Further, when the road surface condition changes, the road surface data is transmitted by the tire-mounted sensor with a transmission interval that is shorter than when the road surface condition does not change. In this way, reducing the amount of road surface data that is transmitted when the road surface condition does not change makes it possible to reduce the amount of power required for data transmission. Further, using a transmission interval that is shorter when the road surface condition changes than when the road surface condition does not change makes it possible for changes in the road surface condition to be conveyed rapidly to a vehicle body side system.

### CROSS REFERENCE TO RELATED APPLICATIONS

The present application is based on Japanese Patent Application No. 2016-131789 filed on Jul. 1, 2016 and Japanese Patent Application No. 2017-110682 filed on Jun. 5, 2017, the contents of which are incorporated herein by reference.

### TECHNICAL FIELD

The present disclosure relates to a tire-mounted sensor for detecting vibrations which a tire receives, generating road surface data indicating a road surface condition based on vibration data and conveying the road surface data to a vehicle body side system. The present disclosure further relates to a road surface estimation device for estimating a road surface condition based on the vibration data.

### BACKGROUND ART

A road surface condition estimation device is proposed conventionally in patent literature 1. This road surface condition estimation device includes a tire-mounted sensor provided at a back surface of a tire tread to detect vibrations applied to a tire and conveys a vibration detection result to a vehicle body side system for estimating a road surface condition. In this road surface condition estimation device, the road surface condition is estimated based on a detection signal of a vibration detection unit provided in the tire-mounted sensor. A level of high frequency components in the detection signal of the vibration detection unit varies with the road surface condition. For this reason, by setting a zone in which a part of the tire tread corresponding to a location of arrangement of the tire-mounted sensor contacts a road surface to be a ground contact zone, the level of high frequency components in the detection signal of the vibration detection unit corresponding to the ground contact zone is used as the road surface data indicating the road surface condition. At every one rotation of tire, the road surface data is transmitted from the tire-mounted sensor to the vehicle body side system and the road surface condition is estimated based on the road surface data in the vehicle body side system. To be in more detail, by using as the road surface data an integrated voltage value resulting from integration of high frequency components in the detection signal indicated as a voltage value, a road surface friction coefficient (hereinafter referred to as road surface μ) is estimated based on a magnitude of the integrated voltage value.

### PRIOR ART LITERATURE

### Patent Literature

JP 2015-174636A

### SUMMARY OF INVENTION

However, in case that the road surface data is transmitted from the tire-mounted sensor at every one rotation of tire to the vehicle body side system, electric power required for transmission increases and a power source for the tire-mounted sensor need be large-sized. It is therefore desired to reduce power required for transmission of the road surface data from the tire-mounted sensor.

For power reduction, it is considered to lengthen a transmission interval to reduce the number of transmissions by transmitting the road surface data at every plural number of rotations of the tire. However, in case that the transmission interval is lengthened simply, it is not possible to convey the road surface data to the vehicle body side system rapidly when the road surface condition changes.

It is therefore an object of the present disclosure to provide a tire-mounted sensor, which reduces power required for data transmission and conveys a change in a road surface condition rapidly to a vehicle body side system, and a road surface condition estimation device including the tire-mounted sensor.

A tire-mounted sensor according to one aspect of the present disclosure is a tire-mounted sensor attached to a back surface of a tire and comprises a vibration detection unit for outputting a detection signal corresponding to a magnitude of vibrations of a tire, a signal processing unit for detecting a road surface condition based on vibration data indicated by the detection signal of the vibration detection unit, a transmission unit for transmitting road surface data indicating the road surface condition. The signal processing unit includes a transmission control unit for setting a transmission interval of the road surface data in correspondence to a change in the road surface condition detected in association with rotation of the tire and controlling the transmission unit to transmit the road surface data.

By thus setting the transmission interval of the road surface data in correspondence to the change in the road surface condition, it is possible to vary the transmission interval and include timing for lengthening the transmission interval. For this reason, in comparison with a case that the transmission interval is always fixed, it is possible to reduce power required for data transmission at lease at timing of lengthening the transmission interval.

For example, the transmission control unit detects a change time, at which the road surface condition changes when the tire rotates, and a no-change time, at which the road surface condition does not change when the tire rotates. The transmission control unit controls the transmission unit to transmit the road surface data at every plural number of rotations of the tire when the road surface condition does not change and transmit the road surface data by making the transmission interval to be shorter when the road surface condition changes than that of the no-change time of the road surface condition.

By thus decreasing the number of times of transmitting the road surface data when the road surface condition does not change, it is made possible to reduce power required for data transmission. Further, by making the transmission interval to be shorter in case of the change time than that of the no-change time.

### BRIEF DESCRIPTION OF DRAWINGS

FIG. 1 is a view showing a block configuration of a vehicle danger avoiding device in a vehicle-mounted state according to a first embodiment;

FIG. 2 is a block diagram of a tire-mounted sensor;

FIG. 3 is a sectional schematic view of a tire to which the tire-mounted sensor is attached;

FIG. 4 is a waveform chart showing an output voltage of an acceleration sensor at time of tire rotation;

FIG. 5A is a chart showing a change in the output voltage of the acceleration sensor in case of traveling on a high p road surface such as an asphalt road, a road surface p of which is comparatively high;

FIG. 5B is a chart showing a change in the output voltage of the acceleration sensor in case of traveling on a low p road surface such as a frozen road, a road surface p of which is comparatively low;

FIG. 6 is a chart showing a result of frequency analysis conducted on the output voltage during a ground contact period with respect to each case of traveling on the high p road and the low p road;

FIG. 7 is a flowchart of zone setting processing, which determines a transmission interval of road surface data;

FIG. 8A is a time chart showing transmission of road surface data at no-change time; and

FIG. 8B is a time chart showing transmission of road surface data at change time.

### EMBODIMENT FOR CARRYING OUT INVENTION

Embodiments of the present disclosure will be described below with reference to the drawings. In each embodiment described below, same or equivalent parts are designated with the same reference numerals.

### First Embodiment

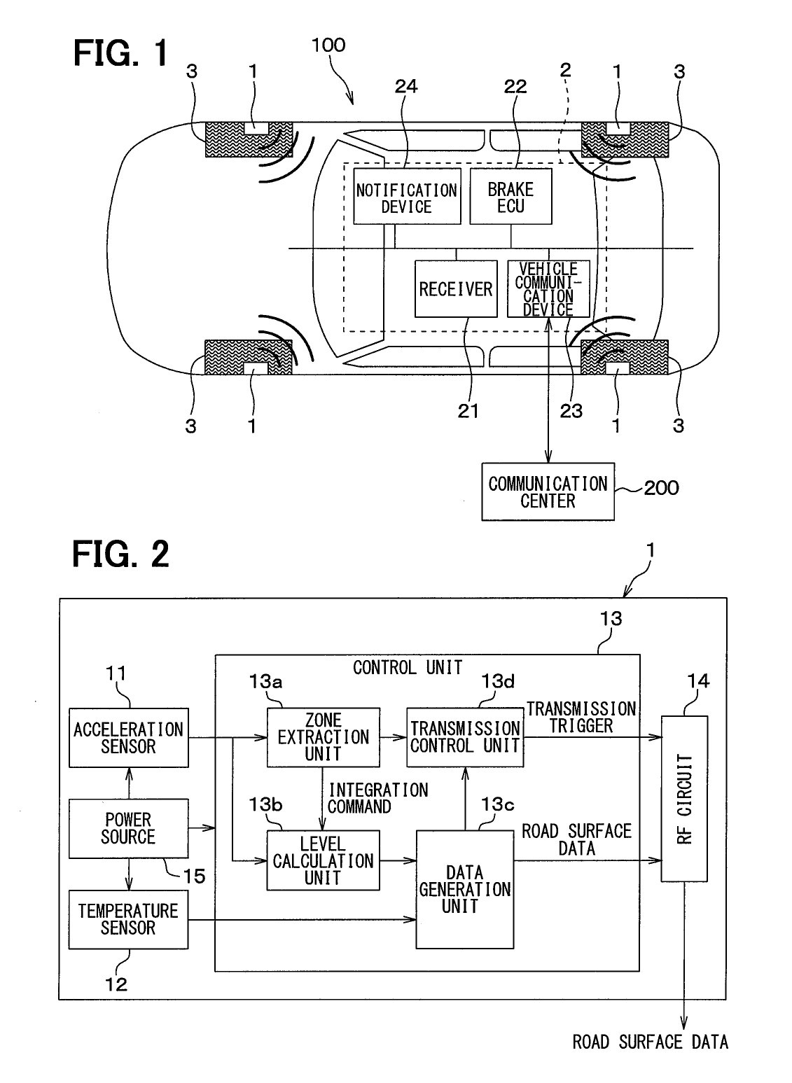

A vehicle danger avoidance device 100 according to the present embodiment, which includes a road surface estimation device, will be described with reference to FIG. 1 to FIG. 8A and FIG. 8B. The vehicle danger avoidance device 100 according to the present embodiment estimates a road surface condition, on which a vehicle travels, based on vibrations applied to a ground contact surface of a tire attached to each wheel of the vehicle and executes notification of vehicle danger and vehicle motion control based on the road surface condition.

As shown in FIG. 1 and FIG. 2, the vehicle danger avoidance device 100 is configured to have a tire-mounted sensor 1 attached to a wheel side and a vehicle body side system 2, which includes various units provided in a vehicle body side. The vehicle body side system 2 includes a receiver 21, an electronic control unit 22 for controlling a braking operation (hereinafter referred to as brake ECU), a vehicle communication device 23 and a notification device 24.

The vehicle danger avoidance device 100 transmits data, which indicate a road surface condition such as data indicating a road surface p between the tire 3 and a travel road from the vehicle-mounted sensor 1. Hereinafter, the road surface μ is referred to as μ data and the data indicating the road surface condition is referred to as road surface data.

In the present embodiment, as shown in FIG. 1, the vehicle danger avoidance device 100 receives by the receiver 21 the road surface data transmitted from the vehicle-mounted sensor 1 and conveys the road surface condition indicated by the road surface data from the notification device 24. It is thus possible to convey to a driver the road surface condition, for example, the road surface μ is low, the road is dry, wet or frozen and warn the driver that the road surface is slippery. By conveying the road surface condition to the brake ECU 22 for executing the vehicle motion control or the like, the vehicle danger avoidance device 100 executes the vehicle motion control for avoiding danger. For example, a braking force generated in correspondence to a brake operation amount is reduced more in case of frozen road time than in case of the dry road time so that the vehicle motion control is executed in correspondence to the low p time. Further, by transmitting the road surface data to a communication center 200 through the vehicle communication device 23, the vehicle danger avoidance device 100 is enabled to make mapping of the road surface condition as described later. More specifically, the vehicle-mounted sensor 1 and the receiver 21 are configured as described below.

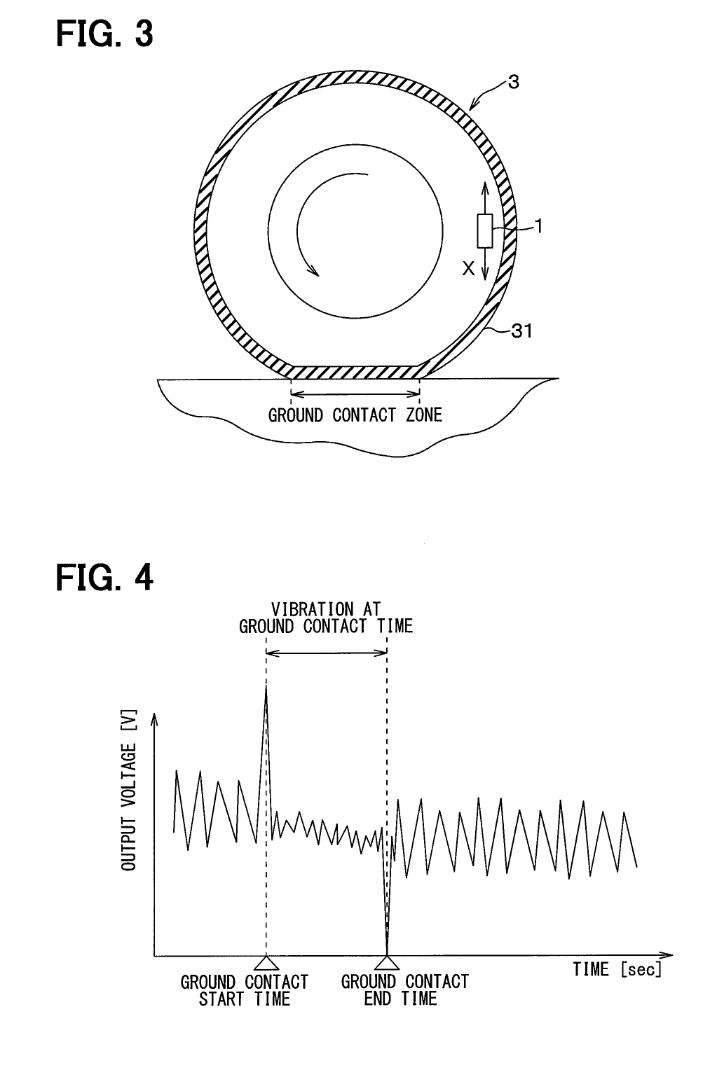

The vehicle-mounted sensor 1 is a tire-side device provided at a tire side. As shown in FIG. 2, the vehicle-mounted sensor 1 is configured to include an acceleration sensor 11, a temperature sensor 12, a control unit 13, an RF circuit 14 and a power source 15. As shown in FIG. 3, the vehicle-mounted sensor 1 is provided on a back surface side of a tire tread 31 of the tire 3.

The acceleration sensor 11 is configured as a vibration detection unit for detecting vibrations applied to a tire. For example, the acceleration sensor 11 outputs an acceleration detection signal as a detection signal corresponding to vibrations in a tire-tangential direction indicated with an arrow X in FIG. 3, that is, a direction tangential to a circular orbit which the tire-mounted sensor 1 depicts when the tire 3 rotates. For more details, the acceleration sensor 11 generates as the detection signal an output voltage, which is positive in one direction and negative in the opposite direction, between two directions indicated with the arrow X.

The temperature sensor 12 outputs a detection signal corresponding to temperature. The temperature sensor 12 measures a temperature of the travel road surface by detecting a temperature of a position in the tire 3 at which the vehicle-mounted sensor 1 is attached.

The control unit 13 corresponds to a signal processing unit. The control unit 13 operates to generate road surface data by using the detection signal of the acceleration sensor 11 as a detection signal, which indicates the vibration data in the tire-tangential direction, and processing this detection signal, and conveys the road surface data to the RF circuit 14. Specifically, the control unit 13 extracts a ground-contact zone of the acceleration sensor 11 during rotation of the tire 3 based on the detection signal of the acceleration sensor 11, that is, a time change of the output voltage of the acceleration sensor 11. The ground-contact zone means an area of a part of the tread 31 of the tire 3, which corresponds to the location of attachment of the acceleration sensor 11 and contacting the road surface. In the present embodiment, since the location of arrangement of the acceleration sensor 11 is the location of arrangement of the vehicle-mounted sensor 1, the ground-contact zone is the same as the area of a portion of the tread 31 of the tire 3, which corresponds to the location of arrangement of the tire-mounted sensor 1 and is in contact with the road surface.

Since the high frequency components included in the detection signal of the acceleration sensor 11 generated during an interval of the ground contact zone indicate the road surface condition, the control unit 13 extracts the high frequency components from the detection signal and detects the road surface condition such as the road surface μ based on the extracted high frequency components as described later.

Further, in the present embodiment, since the temperature of the travel road surface is measured by the temperature sensor 12, the control unit 13 detects the road surface condition and correction of the road surface condition determined from the high frequency components of the detection signal of the acceleration sensor 11 based on the temperature of the travel road surface.

The control unit 13, thus detecting the road surface condition, generates the road surface data indicating the road surface condition and executes processing of conveying it to the RF circuit 14. The road surface data is thus conveyed to the receiver 21 through the RF circuit 14. If the RF circuit 14 transmits the road surface data at every one rotation of the tire 3, power consumption increases. For this reason, the number of transmissions is decreased by lengthening the transmission interval. In case that the transmission interval is lengthened simply, it is not possible to convey the change in the road surface condition rapidly when the road surface condition changes. For this reason, the transmission interval is set in correspondence to the change in the road surface condition.

Specifically, the control unit 13 is formed of a conventional microcomputer including a CPU, a ROM, a RAM, an I/O and the like and executes the processing described above based on a program stored in the ROM or the like. The control unit 13 includes, as functional units for executing such processing, a zone extraction unit 13a, a level calculation unit 13b, a data generation unit 13c and a transmission control unit 13d.

The zone extraction unit 13a extracts the ground contact zone by detecting a peak value of the detection signal indicated by the output voltage of the acceleration sensor 11. The output voltage waveform of the acceleration sensor 11 during rotation changes as shown in FIG. 4, for example. As shown in this figure, at a ground contact start time at which the part of the tread 31 corresponding to the location of arrangement of the acceleration sensor 11 starts contacting the ground during the rotation of the tire 3, the output voltage of the acceleration sensor 11 takes a maximum value. The zone extraction unit 13a detects the ground contact start time, at which the output voltage of the acceleration sensor 11 takes the maximum value, as a first peak value timing. Further, as shown in FIG. 4, at a ground contact end time at which the part of the tread 31 corresponding to the location of arrangement of the acceleration sensor 11 ends contacting the ground during rotation of the tire 3, the output voltage of the acceleration sensor 11 takes a minimum value. The zone extraction unit 13a detects the ground contact end time at which the output voltage of the acceleration sensor 11 takes the minimum value as a second peak value timing.

The output voltage of the acceleration sensor 11 takes the peak values at the above-described timings for the following reasons. When the part of the tread 31 corresponding to the location of arrangement of the acceleration sensor 11 comes to contact the ground during rotation of the tire 3, the part of the tire 3 having been in generally cylindrical shape near the acceleration sensor 11 is pressed and deformed in a planar shape. Receiving shock at this time, the output voltage of the acceleration sensor 11 takes the first peak value. When the part of the tread 31 corresponding to the location of arrangement of the acceleration sensor 11 leaves the ground surface during rotation of the tire 3, the part of the tire 3 is released from pressurization and restores to the generally cylindrical shape from the planar shape. Receiving shock at the time of restoring the original shape of the tire 3, the output voltage of the acceleration sensor 11 takes the second peak value. As described above, the output voltage of the acceleration sensor 11 takes the first peak value and the second peak value at the ground contact start time and the ground contact end time, respectively. Since a direction of shock at the time when the tire 3 is pressed and a direction of shock at the time when the tire 3 is released from pressurization are opposite, polarities of the output voltages are also opposite.

The zone extraction unit 13a extracts the ground contact zone of the acceleration sensor 11 by extracting the data of the detection signal including the timings of the first peak value and the second peak value and conveys that it is within the ground contact zone to the level calculation unit 13b.

Since the output voltage of the acceleration sensor 11 takes the second peak value at the ground contact end time of the acceleration sensor 11, the zone extraction unit 13a transmits the detection signal to the transmission control unit 13d at this timing. Thus one rotation of the tire 3 is conveyed to the transmission control unit 13d.

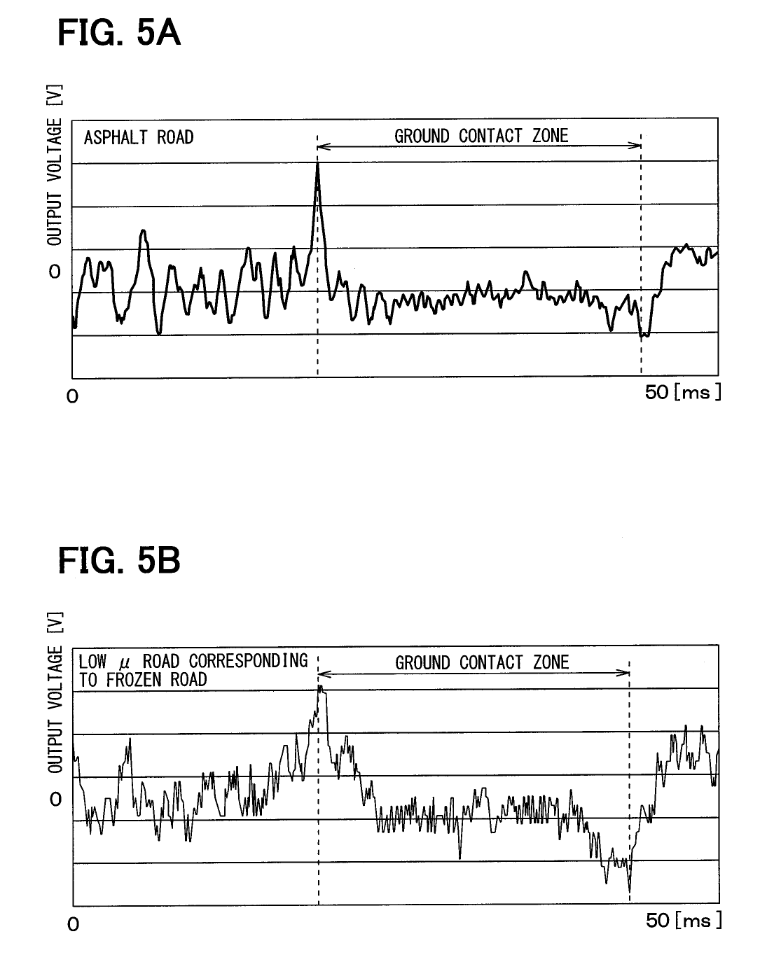

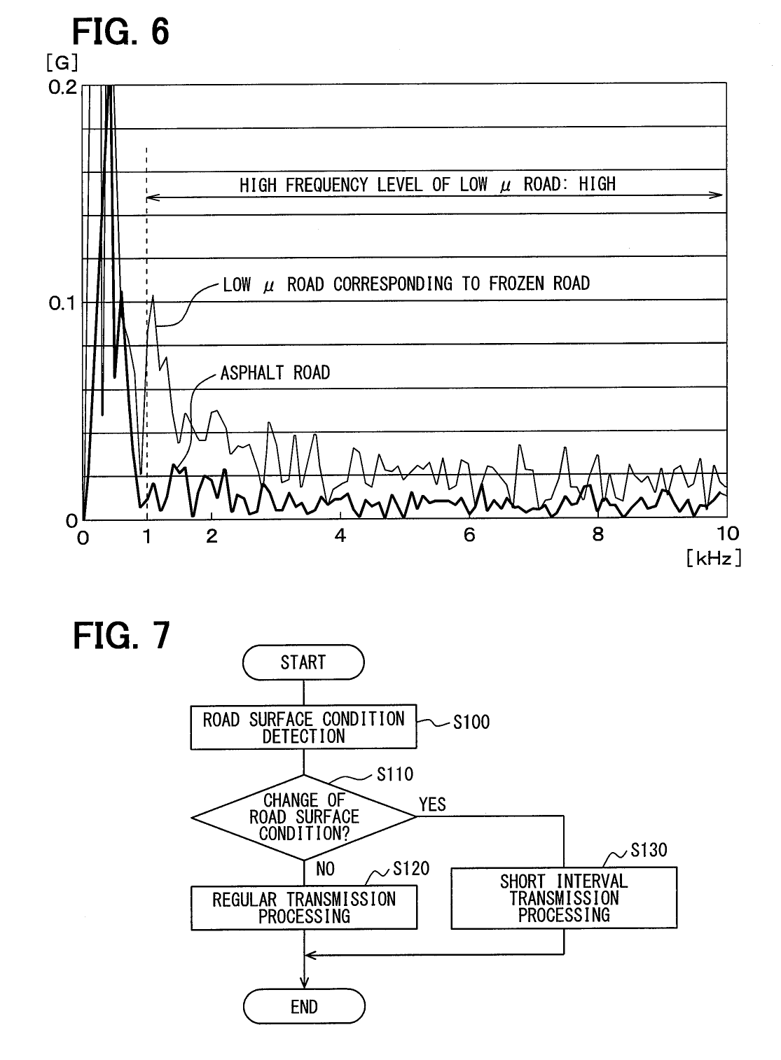

When it is conveyed from the control unit 13 that it is within the ground contact zone, the level calculation unit 13b calculates a level of the high frequency components, which arise from vibration of the tire 3 and is included in the output voltage of the acceleration sensor 11 during the interval of the ground contact zone. The level calculation unit 13b conveys such a calculation result to the data generation unit 13c as the road surface data such as the p data. The level of the high frequency components is calculated as an index indicating the road surface condition such as the road surface μ for the following reasons described below with reference to FIG. 5A, FIG. 5B and FIG. 6.

FIG. 5A shows a change of the output voltage of the acceleration sensor 11 in case of traveling on the high p road surface like an asphalt road, the road surface μ of which is comparatively large. FIG. 5B shows a change of the output voltage of the acceleration sensor 11 in case of traveling on the low μ road surface like a road corresponding to a frozen road, the road surface μ of which is comparatively small.

As is evident from those figures, the first peak value and the second peak value appear at the start and the end of the ground contact zone, that is, the ground contact start time and the ground contact end time of the acceleration sensor 11, respectively, regardless of the road surface p. However, the output voltage of the acceleration sensor 11 changes as affected by the road surface μ. For example, in case that the road surface μ is low like traveling on the low μ road surface, fine high frequency vibration caused by slipping of the tire 3 is superimposed on the output voltage. This fine high frequency noise caused by slipping of the tire 3 is not superimposed in case that the road surface μ is high like traveling on the high p road surface.

For this reason, frequency analysis of the output voltage in the ground contact zone with respect to the high road p and low road μ produces results shown in FIG. 6. That is, the frequency analysis result indicates a high level in a low frequency band in any cases of traveling the high μ road surface and the low μ road surface. However, in a high frequency band of 1 kHz or more, the level is higher in case of the low road surface μ. For this reason, the level of the high frequency components of the output voltage of the acceleration sensor 11 is the index indicating the road surface condition.

Therefore, by calculating the level of the high frequency components of the output voltage of the acceleration sensor 11 in the ground contact zone by the level calculation unit 13b, it is possible to use the calculated level as μ data. Further, it is possible to detect a type of the road surface corresponding to the road surface μ as the road surface condition. For example, it is possible to determine the frozen road when the road surface μ is low.

For example, the high frequency component level is calculated by extracting the high frequency components from the output voltage of the acceleration sensor 11 and integrating the high frequency components extracted during the interval of the ground contact zone. Specifically, the high frequency components of the frequency band fa to fb, in which it is assumed to change in correspondence to the road surface condition or the road surface μ, are extracted by filtering or the like and a voltage of the high frequency components in the frequency band fa to fb extracted by the frequency analysis. For example, the high frequency components are charged in a capacitor. Thus the charge amount is greater in case that the road surface μ is low like traveling on the low p road surface than in case that the road surface μ is high like traveling on the high μ road surface. By thus using the charge amount as the p data, it is possible to estimate the road surface μ is lower as the charge amount indicated by the μ data is greater.

The data generation unit 13c basically generates the road surface data based on the calculation result of the level calculation unit 13b. For example, the data generation unit 13c uses the generated data as it is as the road surface data or generates data as the road surface data by determining the road surface condition like the frozen road or the asphalt road based on the μ data.

Further, as described above, the temperature of the travel road surface is detected by the temperature sensor 12 in the present embodiment. The data generation unit 13c acquires the road surface temperature by receiving the detection signal of the temperature sensor 12, detects the type of the road surface based on the acquired road surface temperature and corrects the μ data or the type of the road surface determined based on the μ data.

For example, in case that the road surface temperature detected by the temperature sensor 12 is lower than 0° C. and negative, the data generation unit 13c detects that the road surface is in the frozen condition as the type of the road surface condition. Further, in case that the μ data determined from the high frequency components of the detection signal of the acceleration sensor 11 or the type of the road surface indicated by the μ data does not match the road surface temperature detected by the temperature sensor 12, the data generation unit 13c corrects it or does not use it as the detection result of the road surface condition. For example, in case that the type of the road surface determined from the high frequency components of the detection signal of the acceleration sensor 11 indicates the frozen condition, the detection result indicating that the type of the road surface is the frozen condition is erroneous if the road surface temperature detected by the temperature sensor 12 is 40° C. In this case, the data generation unit 13c does not use the result conveyed from the level calculation unit 13b as the detection result of the type of the road surface. Similarly, in case that the road surface μ indicated by the μ data does not match the type of the road surface determined from the road surface temperature, for example, in case that the road surface μ indicated by the μ data is high contrary to the detection that the road surface temperature indicates the frozen condition, the data generation unit 13c corrects the road surface μ indicated by the μ data to a lower value than before the correction.

The transmission control unit 13d detects a change in the road surface condition based on the road surface data generated by the data generation unit 13c. The transmission control unit 13d then sets the interval of transmission of the road surface data by the RF circuit 14, that is, the transmission interval, in correspondence to a change in the detected road surface condition and outputs the transmission trigger to the RF circuit 14 in correspondence to the set interval. For example, in case of a change from dry road to wet road or conversely from the wet road to the dry road, or a change from the high μ road to the low p road or from the low p road to the high μ road, it is detected as the change in the road surface condition. In correspondence to the change in the road surface condition, for example, at the time of change, the transmission trigger is outputted from the transmission control unit 13d. It is noted as described later that the transmission trigger is outputted in correspondence to the change in the road surface condition, for example, at every one or plural number of rotations of the tire 3 in the present embodiment. The transmission trigger may be outputted at an arbitrary timing in rotation of the tire 3. For example, the transmission trigger is outputted at the ground contact end time, that is, at the timing that the output voltage of the acceleration sensor 11 becomes the second peak value which is the minimum value.

Specifically, in case of no-change time at which the road surface condition indicated by the data generated by the data generation unit 13c does not change, the transmission control unit 13d generates the transmission trigger so that the road surface data is transmitted at a predetermined transmission interval as a regular transmission. In this no-change time, the transmission interval is set so that the road surface data is transmitted once at every plural number of rotations of the tire 3. This setting is for improving battery life by reducing power consumption and preventing that the receiver 21 is disabled to receive the trigger signal because of overlapping of data transmission with other wheels. For example, the road surface data is transmitted once in every five rotations of the tire 3. In this case, the road surface data is transmitted to the vehicle body side system 2 at every travel of 10 meters.

In case of a change time at which the road surface condition indicated by the data generated by the data generation unit 13c changes, the transmission control unit 13d generates the transmission trigger so that the road surface data is transmitted at a predetermined transmission interval shorter than that of the no-change time as a short interval transmission. For example, in this change time, the transmission interval is set so that the road surface data is transmitted once at every one rotation of the tire 3. In this case, the road surface data may be transmitted only once at every one rotation of the tire 3 or alternatively the same road surface data may be transmitted plural times at every one rotation of the tire 3. By thus transmitting the road surface data plural times at every one rotation of the tire 3, even when either one of the transmission data transmitted plural times is not received by the receiver 21 because of nulling or the like, it is possible to receive remaining transmission data by the receiver 21. Therefore it is possible to convey the transmission data to the vehicle body side system 2 more surely.

It is noted in the present embodiment that, since the detection signal is transmitted from the zone extraction unit 13a to the transmission control unit 13d at every timing that the acceleration sensor 11 ends the ground contact, the transmission control unit 13d can detect the number of rotations of the tire 3 based on the detection signal. It is of course possible to detect the number of rotations of the tire 3 similarly by, for example, transmitting the detection signal from the zone extraction unit 13a each time the output voltage of the acceleration sensor 11 takes the first peak value or each time the ground contact zone is extracted.

The RF circuit 14 forms a transmission unit, which transmits the road surface data such as the μ data conveyed from the data generation unit 13c to the receiver 21. In this embodiment, the road surface data is transmitted based on the transmission trigger from the transmission control unit 13d. The communication between the RF circuit 14 and the receiver 21 may be executed by conventional short-range radio communication technology like Bluetooth (registered trademark). Although the road surface data may be transmitted at arbitrary timing, the road surface data is transmitted at a rate of once at every plural number of rotations of the tire 3 in the no-change time of the road surface condition in the present embodiment. The road surface data is transmitted at every one rotation of the tire 3 in the change time of the road surface condition by shortening the transmission interval than in the no-change time. It is thus possible to reduce power consumption at the time of no change in the road surface condition by decreasing the transmission of the road surface data and rapidly convey the change in the road surface condition to the vehicle body side system 2 at the time of change in the road surface condition by increasing the transmission of the road surface data than in case of the no-change time.

The road surface data is transmitted together with an individual identification information (hereinafter referred to as ID information), which is predetermined to each wheel of the tire 3 of the vehicle. The position of each wheel is specified by a conventional wheel position detection device, which detects which wheel is attached to which position of the vehicle. Therefore, by conveying the road surface data together with the ID information to the receiver 21, it is possible to determine to which wheel the received data corresponds.

The power source 15 is formed of a battery, for example, and supplies power to drive each section of the tire-mounted sensor 1.

The receiver 21 receives the road surface data transmitted from the vehicle-mounted sensor 1, estimate the road surface condition based on the received road surface data, conveys the estimated road surface condition to the notification device 24 and conveys, if necessary, the road surface condition to the driver from the notification device 24. Thus, the driver tries to drive the vehicle in a manner matching the road surface condition and is enabled to avoid danger to the vehicle. For example, the estimated road condition may be displayed always by the notification device 24 or the road surface condition may be displayed to warn the driver only when the vehicle need be driven more carefully than usual, for example, when the estimated road condition corresponds to the low p road like the wet road or the frozen road. Further, the road surface condition is conveyed to an ECU such as the brake ECU 22, which executes the vehicle motion control, from the receiver 21 so that the vehicle motion control is executed based on the conveyed road condition. Still further, the receiver 21 executes processing of outputting the road surface data to the vehicle communication device 23. Thus, the road surface data is transmitted from the vehicle communication device 23 to the communication center 200 which collects the road information.

The brake ECU 22 forms a braking control device which executes various braking controls. Specifically, the brake ECU 22 increases and decreases a wheel cylinder pressure to control a braking force by driving an actuator, which controls a brake fluid pressure. The brake ECU 22 is capable of further controlling independently the braking force of each wheel. When the road surface condition is conveyed from the receiver 21, the brake ECU 22 controls the braking force as the vehicle motion control based on the conveyed road surface condition. For example, in case that the conveyed road surface condition indicates the frozen road, the brake ECU 22 operates to reduce the braking force, which is to be generated in correspondence to an amount of braking operation of the driver, in comparison to a case that the road surface μ is high. It is thus possible to suppress wheel slipping and avoid danger of the vehicle.

The vehicle communication device 23 is capable of inter-vehicle communication and executes information exchange with the communication center 200 via a communication system, which is provided along a road although not shown. In the present embodiment, the vehicle communication device 23 transmits the road surface data conveyed from the receiver 21 to the communication center 200. The vehicle communication device 23 is also capable of oppositely receiving accurate road surface data from the communication center 200.

The notification device 24 is configured with a meter display device for example and used to notify the driver of the road surface condition. In case that the notification device 24 is configured with the meter display device, it is located at a position which the driver is capable of recognition during driving of the vehicle, for example, within an instrument panel in the vehicle. The meter display device notifies the driver visually of the road surface condition in a mode enabling recognition of the road surface condition by displaying the road surface condition, when the road surface condition is conveyed from the receiver 21.

The notification device 24 may alternatively be configured with a buzzer or voice guidance device. In such a case, the notification device 24 notifies the driver of the road surface condition audibly by buzzer sound or voice guidance. Although the meter display device is exemplarily referred to as the notification device 24 for providing visual notification, the notification device 24 may be configured with a display device like a head-up display which provides information display.

The vehicle danger avoidance device 100 according to the present embodiment is configured as described above. Each unit forming the vehicle body side system 2 is connected through an in-vehicle LAN (Local Area Network) like CAN (Controller Area Network) communication. Thus each unit is capable of communicating information mutually through the in-vehicle LAN.

On the other hand, the communication center 200, which executes information exchange about the road surface data with the vehicle danger avoidance device 100, not only collects road information but also supplies the vehicle and the like with road information. Although the communication center 200 and the vehicle communication device 23 may be configured to be able to execute direct communication, the communication center 200 is configured to be able to communicate with the vehicle communication device 23 through communication systems provided at various locations such as roads.

In the present embodiment, the communication center 200 manages information of road surface conditions of various locations of each road included in a map data and executes mapping of the road surface condition, which varies from time to time, based on the received road surface data. That is, the communication center 200 updates the information of the road surface condition of each location of the road included in the map data based on the received road surface data. The communication center 200 provides the vehicle with the road surface data from the updated database.

Specifically, the communication center 200 collects the road surface data transmitted from the vehicle about the road, which the vehicle travelled, and updates the road surface data of each road included in the map data based on the collected road surface data. The communication center 200 further collects weather information and corrects each road surface data based on the weather information and the like thereby to update it for more accurate road surface data. For example, the communication center 200 acquires information related to snow accumulation or frozen road surface as the weather information. As for the road surface covered with snow or frozen, the corresponding road surface data is updated and more accurate road surface data is successively stored. The communication center 200 provides the vehicle with the road surface data stored in the database thereby to convey more accurate road surface data to the vehicle. The communication center 200 updates the road surface data of each road included in the map data stored in the database by collecting road surface data from a number of vehicles. As a result, each vehicle is capable of acquiring the road surface data of not only the present position but also the road, on which the vehicle is scheduled to travel.

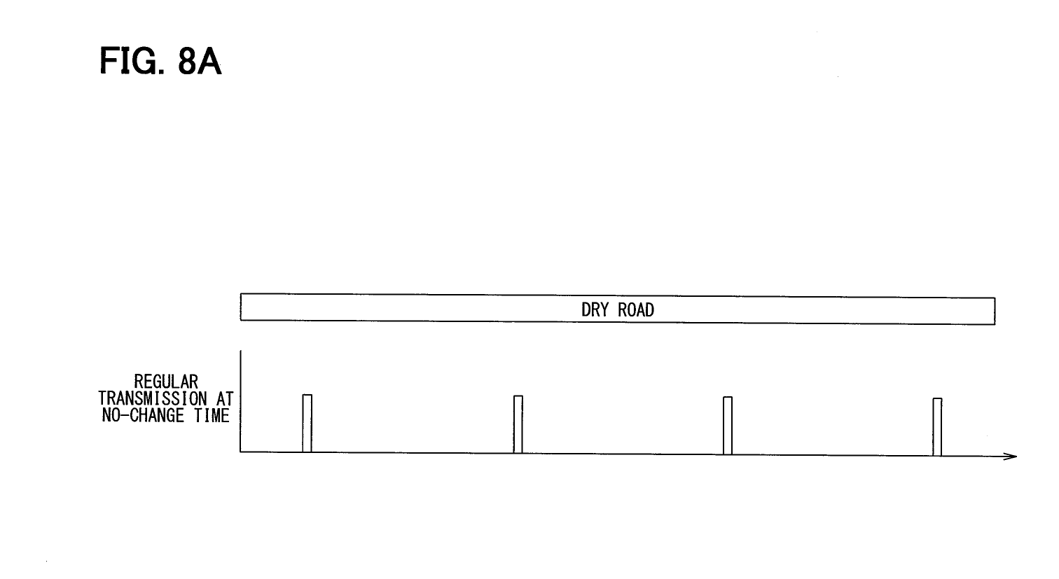

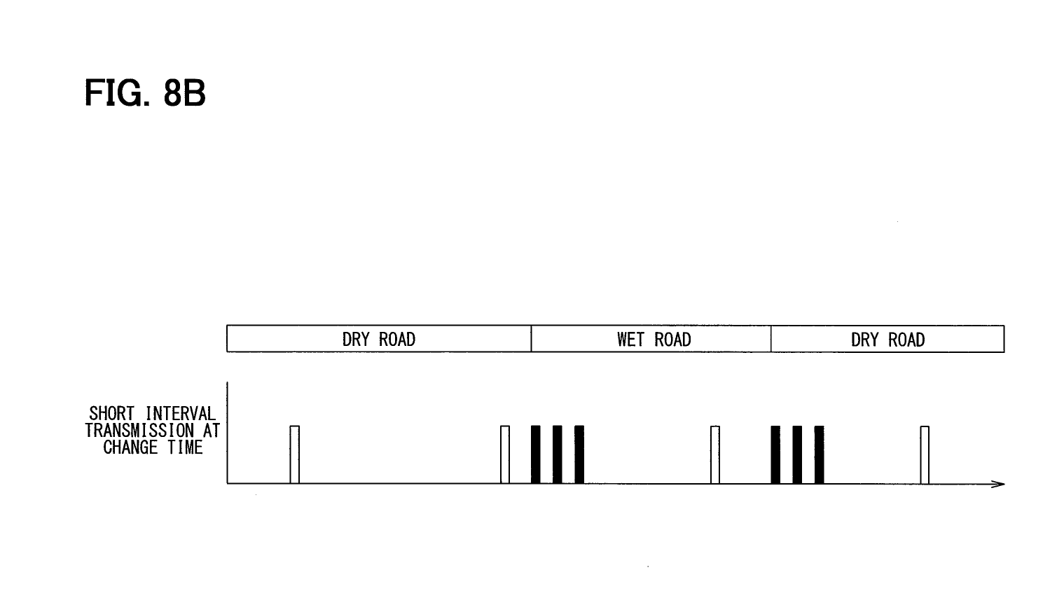

An operation of the vehicle-mounted sensor 1 of the vehicle danger avoidance device 100 according to the present embodiment will be described next with reference to FIG. 7, FIG. 8A and FIG. 8B.

In the vehicle-mounted sensor 1 of each wheel, road surface data transmission processing shown in FIG. 7 is executed by the control unit 13. This processing is executed with power supply from the power source 15 at every one rotation of the tire 3, for example.

At step S100, processing of road surface detection is executed. Specifically, the road surface condition is detected by extracting the high frequency components from the detection signal, that is, output voltage, of the acceleration sensor 11 and detecting the road surface μ or detecting the type of the road surface based on the high frequency components extracted in the ground contact zone. The p data indicating the road surface μ or the road surface data including the type of road surface is generated.

Next, at step S110, the road surface condition acquired at step S100 and the road surface condition acquired in the previous tire rotation are compared thereby to check whether there occurred any change in the road surface condition. It is determined that the road surface condition changed in case that the type of the road surface changed like a switchover from the wet road to the dry road or the road surface μ changed like a switchover from the high condition indicating that the road surface μ is equal to or higher than a predetermined threshold value to the low condition, for example.

In case of a negative determination at step S110, step S120 is executed to execute regular transmission processing so that the road surface data is transmitted at every transmission interval of no-change time of road surface condition. That is, as shown in FIG. 8A, the road surface data is transmitted toward the receiver 21 from the RF circuit 14 at every predetermined transmission interval set as the regular transmission, for example, at a rate of once in every plural number of rotations of the tire 3. FIG. 8A shows, as one example of the no-change time, that the vehicle continues to travel on the dry road.

In case of a positive determination at step S110, on the other hand, step S130 is executed to execute short-interval transmission processing so that the road surface data is transmitted at every transmission interval of change time, which is set to be shorter than that of the no-change time. That is, as shown in FIG. 8B, the road surface data is transmitted toward the receiver 21 from the RF circuit 14 at every predetermined transmission interval set as the short interval transmission, for example, at a rate of once or plural times in every one rotation of the tire 3. FIG. 8B shows, as one example of the change time, that the vehicle travels on the road which changes from the dry road to the wet road and then changes again to the dry road.

Thus, the road surface data is transmitted once or plural times each time the tire 3 makes plural rotations when the road surface condition does not change but the road surface data is transmitted by shortening the transmission interval than that of the no-change time when the road surface condition changes.

As described above, the vehicle danger avoidance device 100 according to the present embodiment sets the transmission interval of the road surface data in correspondence to the change in the road surface condition. By thus setting the transmission interval of the road surface data in correspondence to the change in the road surface condition, it is possible to vary the transmission interval and include the timing of lengthening the transmission interval. For this reason, it is possible to reduce power required for data transmission at least at the timing of lengthening the transmission interval in comparison to the case of setting the transmission interval to be always constant.

Specifically, in the vehicle danger avoidance device 100 according to the present embodiment, the road surface data is transmitted at a rate of once at every plural number of rotations of the tire 3 so that consumed power of the power source 15 is reduced in case of no-change in the road surface condition. Further, in the vehicle danger avoidance device 100, the road surface data is transmitted by shortening the transmission interval in the change time of the road surface condition in comparison to that in the no-change time. By thus reducing the transmission of the road surface data in the no-change time of the road surface condition, it is possible to reduce the power required for the data transmission. Further, by shortening the transmission interval in the change time in comparison to that in the no-change time, the road surface data is transmitted once or plural times at every one rotation of the tire 3, for example. As a result, it is possible to convey the change in the road surface condition rapidly to the vehicle body side system 2.

Further, by transmitting the same road surface data plural times at every one rotation of the tire 3, even when either one of the transmission data transmitted plural times is not received by the receiver 21 because of nulling or the like, it is possible to receive remaining transmission data by the receiver 21. Therefore it is possible to convey the transmission data to the vehicle body side system 2 more surely.

### Other Embodiment

The present disclosure made with reference to the embodiment described above is not limited to the disclosed embodiment but may include various modifications and variations which are within equivalent scopes. In addition, various combinations and forms as well as other combinations and forms, which include only one element, more or less than that, are covered by and within the scope of the present disclosure.

For example, in the present embodiment, as one example of setting the transmission interval of the road surface data in correspondence to the change in the road surface condition, the change time and the no-change time of the road surface condition are detected and the transmission interval is shortened in the case of the change time than in the case of the no-change time. This is just one exemplary case of setting the transmission interval of the road surface data and the transmission interval may alternatively be changed differently. For example, the transmission interval of the road surface data may be set shorter at the no-change time of the road surface condition than at the change time of the road surface condition. Since this setting also includes timing of lengthening the transmission interval, it is possible to reduce the power required for the data transmission at least at timing of lengthening the transmission interval in comparison to a case of setting the transmission interval to be always constant. Further, although both of the change time and the no-change time are detected with respect to the change in the road surface condition, the transmission interval of the road surface data may be varied at the change time to be shorter than that before the change by detecting only the change time.

Further, in the present embodiment, the transmission interval of the road surface condition is set in correspondence to the change in the road surface condition in response to each detection of the change in the road surface condition. However, since the road surface condition is possibly detected erroneously because of noise, the transmission interval may be set in correspondence to the change in the road surface condition on condition that the same changed road surface condition continues even in the following tire rotation after the detection of the change in the road surface condition. According to this setting, it is possible to prevent the erroneous detection of change in the road surface condition caused by noise from being notified to the driver.

However, in some cases, it is preferred that the vehicle motion control is executed rapidly in response to the change in the road surface condition. For this reason, it is allowable to differentiate the timing of notification by the notification device 24 and the timing of executing the vehicle motion control corresponding to the road surface condition. That is, as for the notification by the notification device 24, it may be executed after the changed road surface condition continues for plural number of rotations of the tire 3 without executing immediately following the detection of the change in the road surface condition. As for the vehicle motion control, it may be executed in correspondence to the changed road surface condition immediately following the detection of the change in the road surface condition.

Further, in the present embodiment, the ground contact zone is specified from the detection signal of the acceleration sensor 11 forming a vibration detection unit and the result of calculation of the level of the high frequency components in the detection signal, which is generated in the ground contact zone, is used as the road surface data. However, this is also one exemplary method of detecting the road surface condition using the detection signal of the vibration detection unit. It is also possible to detect the road surface condition by other methods using the detection signal of the vibration detection unit. Further, although the vibration detection unit is formed exemplarily of the acceleration sensor 11, the vibration detection unit may be formed of other vibration detection elements such as a piezoelectric component. Further, the power source 15 may be formed of a power generating element without being limited to batteries. For example, in case of using the vibration detecting element, the vibration detection element forms not only the vibration detection unit but also the power source 15.

Further, in the present embodiment, the receiver 21 performs the function of the control unit, which checks the change in the road surface condition based on the road surface data. However, this is just one example. Alternatively, a control unit may be provided separately from the receiver 21 or other ECUs such as the brake ECU 22 may be used to operate as the control unit.

Further, in the present embodiment, the road surface estimation device is incorporated within the vehicle danger avoidance device. A part of the vehicle danger avoidance device, for example, the tire-mounted sensor 1 and the receiver 21, which estimates the road surface condition in the present embodiment, corresponds to the road surface condition estimation device. However, the road surface estimation device may be configured separately from the vehicle danger avoidance device.

What is claimed is:

1. A tire-mounted sensor attached to a back surface of a tire comprising:
a vibration detection unit for outputting a detection signal corresponding to a magnitude of vibration of the tire;
a signal processing unit for detecting a road surface condition based on vibration data indicated by the detection signal of the vibration detection unit; and
a transmission unit for transmitting road surface data indicating the road surface condition,
wherein the signal processing unit includes a transmission control unit for setting a transmission interval of transmitting the road surface data in correspondence to a change in the road surface condition detected in association with rotation of the tire and controlling the transmission unit to transmit the road surface data.

2. The tire-mounted sensor according to claim 1, wherein:
the transmission control unit varies the transmission interval of transmitting the road surface data in correspondence to the change in the road surface condition.

3. The tire-mounted sensor according to claim 1, wherein:
the transmission control unit detects a change time of the change in the road surface condition and sets the transmission interval of transmitting the road surface data to be shorter than before detection of the change time in response to the detection of the change time.

4. The tire-mounted sensor according to claim 3, wherein:
the transmission control unit controls the transmission unit to transmit the road surface data at a rate of once at every plural number of rotations of the tire before the detection of the change time and controls the transmission unit to transmit the road surface data at a rate of once at every one rotation of the tire at the change time.

5. The tire-mounted sensor according to claim 3, wherein:
the transmission control unit controls the transmission unit to transmit the road surface data at a rate of once at every plural number of rotations of the tire before the detection of the change time and controls the transmission unit to transmit the road surface data at a rate of plural times at every one rotation of the tire at the change time.

6. The tire-mounted sensor according to claim 1, wherein:
the transmission control unit detects a change time of a change in the road surface data and a no-change time of no change in the road surface data, and controls the transmission unit to transmit the road surface data at every plural number of rotations of the tire in case of the no-change time and controls the transmission unit to transmit the road surface data by setting the transmission interval of transmitting the road surface data to be shorter in case of the change time than in case of the no-change time.

7. The tire-mounted sensor according to claim 6, wherein:
the transmission control unit controls the transmission unit to transmit the road surface data at a rate of once at every plural number of rotations of the tire in case of the no-change time and controls the transmission unit to transmit the road surface data at a rate of once at every one rotation of the tire at the change time.

8. The tire-mounted sensor according to claim 6, wherein:
the transmission control unit controls the transmission unit to transmit the road surface data at a rate of once at every plural number of rotations of the tire in case of the no-change time and controls the transmission unit to transmit the road surface data at a rate of plural times at every one rotation of the tire in case of the change time.

9. The tire mounted sensor according to claim 1, wherein the signal processing unit includes:
a ground contact zone specifying unit for specifying a ground contact zone, which is a part of the tire corresponding to a location of arrangement of the vibration detection unit and contacts a ground in one rotation of the tire; and
a high frequency level calculation unit for calculating a level of high frequency components of the detection signal outputted in the ground contact zone, and
the transmission unit transmits a result of calculation of the level of the high frequency components as road surface data indicating the road surface condition.

10. A road surface condition estimation device comprising:
the tire-mounted sensor according to claim 1; and
a vehicle body side system including a control unit provided on a vehicle body side for receiving the road surface data transmitted from the transmission unit and estimating the road surface condition based on the road surface data.

11. A vehicle danger avoidance device comprising:
the road surface condition estimation device according to claim 10,
wherein the vehicle body side system includes a notification device for executing notification to a driver, and
the control unit executes the notification corresponding to an estimated road surface condition through the notification device.
